(19) United States
(12) Patent Application Publication
(10) Pub. No.: US 2007/0012493 A1
(43) Pub. Date: Jan. 18, 2007

(54) Dual hybrid propulsion system

(76) Inventor: Steven Mark Jones, Mason, NH (US)

Correspondence Address: Steven Mark Jones, 346 Old Ashby Road, Mason, NH, 03048, US

(21) Appl. No.: 11/455,871

(22) Filed: Jun. 19, 2006

Related U.S. Application Data
(60) Provisional application No. 60/692,633, filed on Jun. 21, 2005.

(51) Int. Cl. B60L 8/00

(52) U.S. Cl. 180/65.3

(57) ABSTRACT

With the growing demand of oil products in the world, this invention can help curb the fuel consumption rate of trucks/large motor vehicles without reducing peak power outputs. A vehicle having a “dual series” hybrid power systems includes two liquid fueled internal combustion engines, each engine having a generator directly connected. There is an electric motor for drivability directly connected to one or more ground engaging wheels. A first electrical storage device (battery pack) stores electricity that powers the electric motor. Two voltage reducers are coupled between both of the generators and the first electrical storage device and has an accessory voltage output, which has a lower voltage than the charging power output of the generators, to keep the accessory second electrical storage device fully charged.

### BACKGROUND OF THE INVENTION

This invention relates to electric hybrid vehicles. There are basically three types of electric propulsion systems known for vehicles.

First, there is a pure electric drive vehicle. The pure electric drive vehicle has an electric motor which receives power from a main battery pack via a controller. The controller controls the speed of the electric motor.

The major disadvantage of a pure electric drive vehicle is that the range is very limited and the vehicle must be stopped and connected to an energy source such as an electrical outlet in order to be recharged.

The second type of electric propulsion system for vehicles is a series hybrid system. There are three major components in a series system: (1) a generator; (2) an electric motor arranged in series; and (3) an engine powering the generator. Mechanical energy generated by the engine is converted to electrical energy by the generator and is then converted back to mechanical energy by the electric motor.

The main advantage of the series hybrid is that it is possible to operate the engine at a fixed operating point within its engine speed/torque map. This point can be selected so that the engine functions with the greatest efficiency or produces particularly low emissions. The disadvantage is that it achieves slightly lower fuel economy on the highway compared to the parallel hybrid design.

The third type of electric propulsion systems is the parallel hybrid system, generally have three component areas. (1) electrical storage mechanism, such as storage batteries, ultracapacitors, or a combination thereof; (2) an electric drive motor, typically powered by the electrical storage mechanism and used to propel the wheels at least some of the time; and (3) an engine, such as a liquid fueled engine (e.g. internal combustion, stirling engine, or turbine engine) typically used to propel the vehicle directly and/or to recharge the electrical storage mechanism.

In parallel hybrid systems, the electric drive motor is alternatively driven by mechanically coupling it to the engine. When coupled, the engine propels the vehicle directly and the electric motor acts as a generator to maintain a desired charge level in the batteries or the ultracapacitor.

While a parallel hybrid system achieves good fuel economy and performance, it must operate in an on and off engine parallel mode. In this mode, the stop-and-go urban driving uses electric power and the engine is used to supplement existing electric system capacity. For long trips, when the battery for the electric motor could be depleted, the vehicle cruises on the small engine and the electric system will provide the peaking power.

This dual series hybrid invention was invented to meet the demands of propelling large trucks/motor vehicles with the greatest fuel economy and overall versatility. In operation it resembles conventional series hybrid propulsion systems but it has two completely separate systems capable of working as one large system or a small system when load requirements are low. Enabling greater fuel economy when driven within the set parameters of the design. This invention functions like a fully controllable variable displacement liquid fueled engine in a series hybrid configuration, using large engine displacement when high power demands and small engine displacements when low power demands. Providing lower fuel consumption than the standard series hybrid design and approaching the fuel economy of a conventional parallel hybrid designs when used in highway applications and displays a major improvements compared to all conventional series and parallel hybrid systems in stop and go traffic conditions.

### SUMMARY OF THE INVENTION

One embodiment of the present invention relates to a vehicle having one but not limited to electric motor and two liquid fueled engines. A first electrical energy storage device is connected to the electric motor for selectively powering the electric motor. Two electrical energy generator (one per liquid fueled engine) is continuously connected to the liquid fueled engines and coupled to the first electrical energy storage device for providing a charging voltage when the liquid fueled engines are operating, and when both liquid fueled engine are operating and the electric motor is powered. Two voltage reducers are directly coupled to both of the electrical energy generators and to the second electrical storage device, having a vehicle accessory voltage output, which is lower than the charging voltage of the electrical energy generators. The vehicle further includes a connection between the electric motor and the liquid fueled engines. At least one ground engaging drive wheel is rotatable by the liquid electric motor.

Due to the inherent, but separate, advantages of both the series and the parallel drives, the above embodiments enables the dual series hybrid vehicle to provide increased fuel economy compared to conventional series hybrid systems. The dual hybrid invention allows a series hybrid configuration to achieve similar highway fuel economy when compared to conventional parallel hybrid designs. This arrangement eliminates the main disadvantage of conventional parallel hybrid designs as used in a vehicle. It has been found that at slow speed, such as stop and go urban driving, the parallel system will allow the main storage battery pack to deplete its energy below a comfortable and usable level of charge. A series hybrid system is more adaptable to urban driving because it constantly funnels limited amounts of electrical energy back into the system's first electrical storage device.

The main negative of a series hybrid system is that it does not permit an adequate charging level to sustain the high energy demand associated with long term, high speed driving. The above-embodiments of the present invention prevent depletion of the first electrical storage device by using two liquid fueled engines and generators to power the first electrical storage device. In addition, the control of the operation of the drive motor is more versatile and overall efficient.

### BRIEF DESCRIPTION OF DRAWINGS

The invention will be further described in the following, in a non-limiting way with reference to the accompanying drawings in which:

FIG. 1 is a top view, block diagram of the power train and the controls for the dual hybrid series vehicle configured according to the present invention, containing: Liquid fueled engine one (1), Generator one (2), First electrical storage device (3), Inverter one (4), Motor/Generator (5), Axle (6), Drive shaft (7), Main control panel (8), Liquid fueled engine two (9), Generator two (10), Second electrical storage device (11), Inverter two (12), Voltage reducer for generator one (13), Voltage reducer for generator two (14), Motor controller (15), Process controller for engine one (16), Process controller for engine two (17), Wheel (18), Throttle position sensor (19), Load/speed monitoring device (20), Manual-automatic selector (21), Electric oil pump for liquid fuel engine one (22), Electric oil pump for liquid fuel engine two (23), Marine heat exchanger (24).

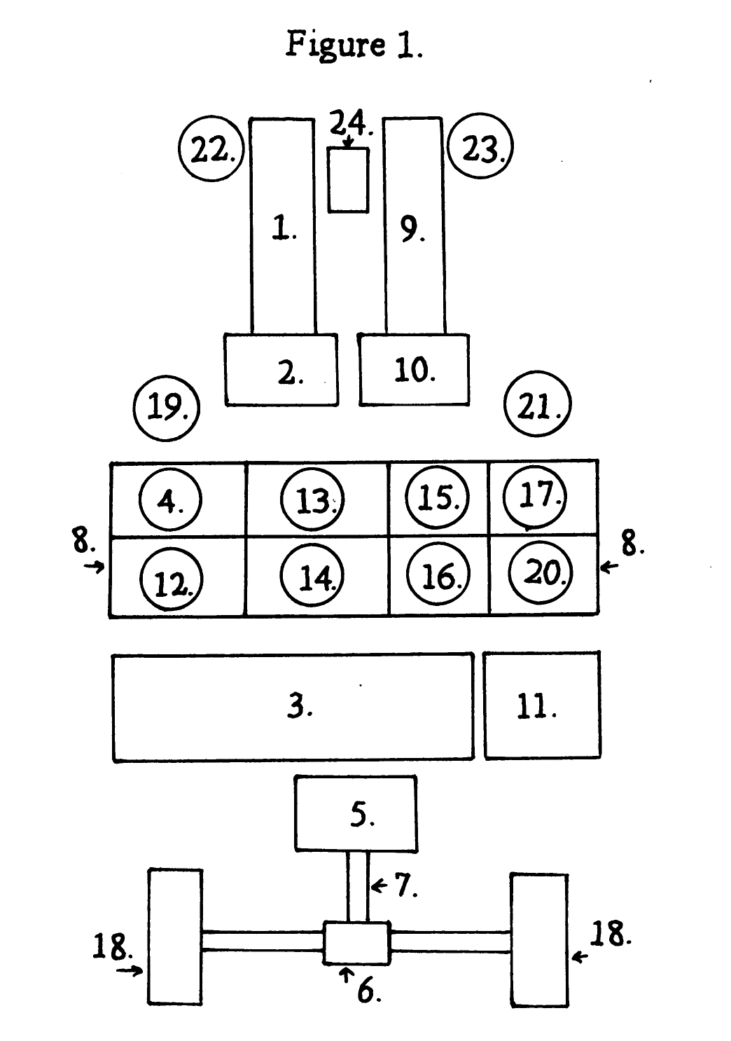

FIG. 2 is a right side view, block diagram of the power train and the controls for the dual hybrid series vehicle configured according to the present invention, containing; First electrical storage device (3), Motor/Generator (5), Axle (6), Drive shaft (7), Main control panel with all its internal subcomponents (8), Liquid fueled engine two (9), Generator two (10) and Wheel (18), Manual-automatic selector (21), Electric oil pump for liquid fuel engine two (23).

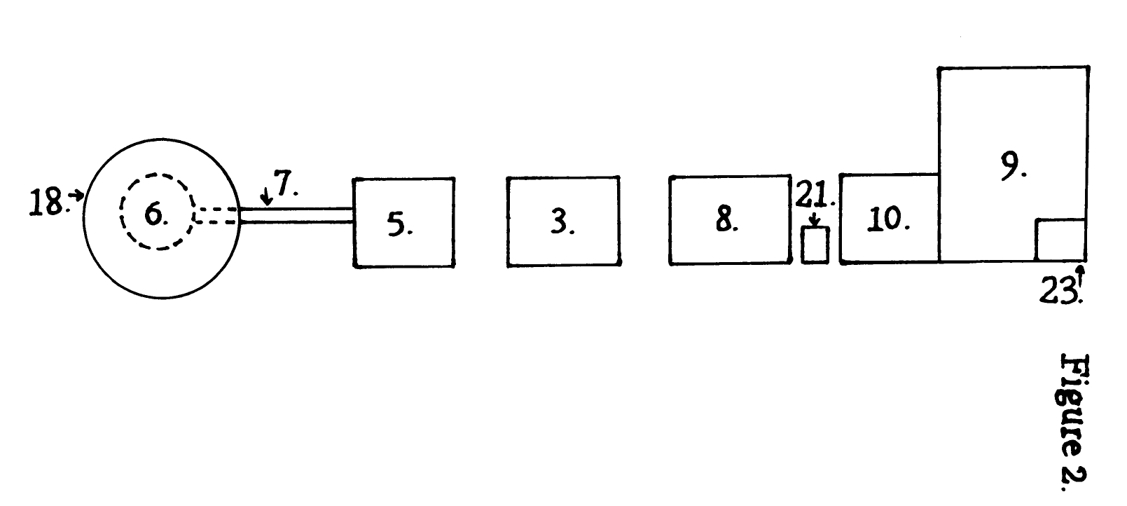

FIG. 3 is a left side view, block diagram of the power train and the controls for the dual hybrid series vehicle configured according to the present invention, containing; liquid fueled engine one (1), Generator one (2), First electrical storage device (3), Motor/Generator (5), Axle (6), Drive shaft (7), Main control panel with all its internal subcomponents (8), Wheel (18), Throttle position sensor (19), Electric oil pump for liquid fuel engine one (22).

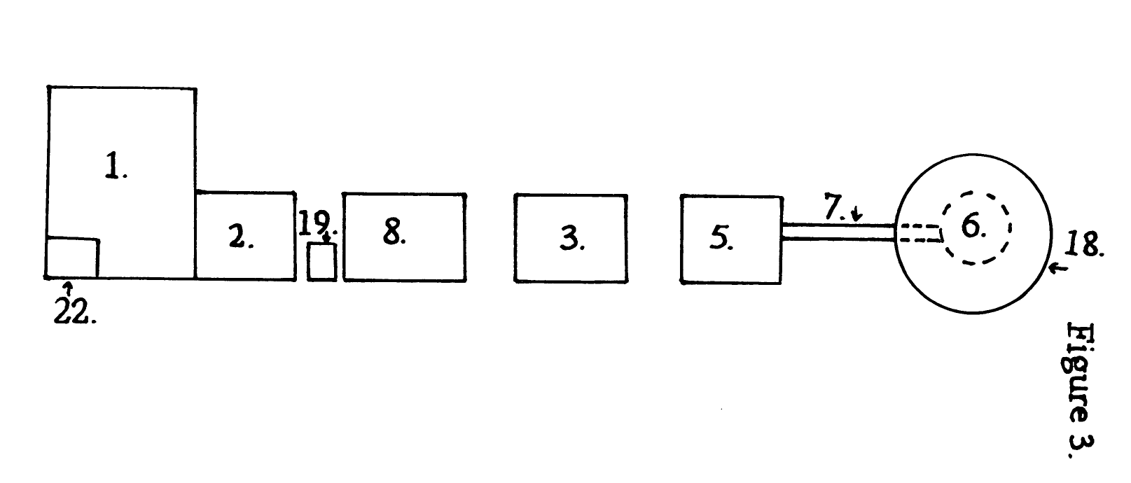

### DETAILED DESCRIPTION

This invention operates as follows:

The Dual Hybrid Propulsion System operates as a series hybrid electric vehicle. When operating in stop and go traffic the vehicle can be powered solely by the first electrical storage device. when fully charged, producing a zero tailpipe emission mode. When the first electrical storage device is drained to a predetermined level one of the two liquid fueled engines will be automatically started by the process controllers and operate the liquid fueled engines will operate at the peak torque curve RPM to recharge them. Once up to full charge the process controller will automatically shutdown the liquid fueled engine until the next time the batteries are depleted to the predetermined level, then the cycle will start again. This provides the highest fuel economy for this driving condition. When rapid acceleration is required, the throttle position sensor sends a signal to the main control panel and the process controller which starts one of the engines to help supplement the first electrical storage device with electrical input power to the motor.

There are 4 manual settings to control the liquid fueled motors, the first is the speed control of the liquid fueled engine one operating at the peak torque curve or the highest fuel economy speed; the second is the speed control of the liquid fueled engine one operating at the peak horse power curve or the highest safe RPM operational speed; the third is the speed control of the liquid fueled engine two operating at the peak torque curve or the highest fuel economy speed; the forth is the speed control of the liquid fueled engine two operating at the peak horse power curve or the highest safe RPM operational speed;

The automatic mode can be switched on and implemented when the manual mode is not desired. It works with the load/speed monitoring device that connects to the vehicles speed odometer and the throttle position sensor and the main control panel working together to choose the proper use of the single or dual liquid fueled engines and set the accurate number of engines engaged and exact engine speed to achieve the highest fuel economy. The automatic mode best on smooth roads and the manual mode works best in some situations as of; hilly roads, stop and go traffic when heavily loaded, ect. A properly trained driver can choose the correct mode to maximize economy.

When the vehicle is driving at low speeds only one of the engines will be operating at it's peak torque curve, this produces the highest volumetric efficiency achievable. This mechanical energy drives the generator and it's electrical output powers the electric motor.

The vehicle can in emergency conditions, reach highway speeds if necessary with only one engine. To achieve this, the engine operates in the emergency mode at it's HP peak and RPM peak, with the electric motor engaged.

There is a marine liquid to liquid heat exchanger that is placed inline between both engines but has it's own separate coolant system, this increases reliability in case of a coolant leak in liquid fueled engine one and two. This separate coolant system, transfers the heat produced from the operating engine to the engine waiting in standby mode.

The standby engine temperature stays at the same as the temperature of the operational engine, at all times. This allows quick start up and full load non-warm up capabilities, as well as dramatically increasing engine life.

This technique allows the use of a medium duty engine to perform in an environment that was exclusively for heavy duty engines. This Dual Hybrid Propulsion System's internal combustion engines in essence, function like a large displacement engine when needed but can shut off half it's engine's total displacement on demand to maximize fuel economy when maximum power is not desired.

When high speeds and/or high output power is essential the secondary engine is engaged operating at peak torque curve producing the highest volumetric efficiency. There are two starting modes. One is the 5 second delay start. When activated there is a small oil pump, the same that is used on high end heavy equipment, that pressurizes the oil lines and prelubes the entire engine with 180 degree oil for 5 seconds. Then the engine is started with completely oiled internal components, this technique almost eliminates engine wear at startup. The process controller on the standby liquid fueled engine engages the electric oil pump every 15 minutes to keep the engines internals semi lubed.

The other is the emergency dry start mode, when activated the liquid fueled engine not operating, starts with no delay and powers the load. This slightly increases engine wear but can produce full load once the engine is up to operating speed due to the preheated engine. There is also a supplementary charge which can be obtained by converting the kinetic energy of the moving vehicle to electric power during braking and deceleration, when the battery is partially depleted.

If the battery bank is at full charge and there is the two motor/generator design, then one electric motor will function as a generator and one electric motor will function as a motor. The one operating like a motor applies input power in the opposite direction of the spin of the motor (reverse torque), converting the mechanical energy to heat from both units.

The other type of system has a heating element and the motor/generator can operate like a generator and the heating element can load the generator to provide dynamic braking.

This dual series hybrid inventions differs from conventional series hybrid designs as of; instead of one large engine that powers a single large generator, there will be two smaller engines that will power two smaller generators. They can power one large or two smaller electric motors for propulsion. The two motor design can be used but not limited to; all wheel drive capability with one motor/generator connected to the front drive shaft and one motor/generator connected to the rear drive shaft. There is a first energy storage device (battery bank) that is connected to the generators and the control electronic unit. There is a main control panel that has two process controllers that handles the first energy storage device charge rate, discharge rate.

The acceleration, maximum set load rating and ect. Are calculated by the load/speed monitoring device and the information is sent to the main control panel to choose the proper engine speed and number of engines engaged.

The operation will be as follows; when the vehicle is driving at low speeds (approximately 35 MPH and under) only one of the liquid fueled engines will be operating at a RPM set between the peak torque curve and peak HP curve, this mechanical energy drives the generator and it's electrical output powers one of the electric motors. The dual hybrid vehicle can in emergency conditions, reach approximately 50-60 MPH on the highway if necessary with only one engine. Operating at peak RPM and peak HP curve and one electric motor engaged.

When the truck is required to drive above 35 MPH, then the secondary engine is engaged. The reason all heavy duty diesel engines weight so much, is due to the need to provide proper structural strength to the lower main bearing support webbing and cylinder head support. Diesel generators have a longer life cycle in hours of use than diesel engines powering a conventional drive system in heavy trucks.

This is because the when a diesel engine powers a conventional drive system, it revs up to a predetermined RPM, which builds up the kinetic energy and is stored within the flywheel. When the truck is shifted into the next higher gear the RPM drop and so does the X amount of stored kinetic energy.

If the engine was made to produce full load at the reduced RPM and if the engines output exceeds the stored kinetic energy in the flywheel. When that transition takes place the once smooth power strokes from the engine now start to pulse. This low speed pulse increases the structural loading of internal components, reducing component life. The strength of the pulses are directly proportional to the differences from the output power vs. the stored kinetic energy.

This is exactly why, an engine stops pulsing (lugging) and smoothens out when a downshift occurs, the kinetic energy stored within the flywheels exceed the engines output once again.

A generator does no pull full load at a low RPM and does not display the low speed pulsing problems of the direct connected driveline, the fixed RPM provides more stored kinetic energy within the generator rotor. Enabling a lighter duty engine to power a hybrid truck that would otherwise be powered exclusively by a heavy duty engine using a conventional drive systems as well as conventional parallel hybrid designs due to the loading and unloading of the direct connected driveline. There is no pulsing on the electric motor/generator only smooth steady power transferred directly to the driveline, therefore increasing the operational life of the driveline.

When the full power mode is desirable for passing, pulling a hill a with full load, brisk accelerating, ect. and with the two smaller liquid fueled engines dividing up the load, means each engine is working like it was pushing a vehicle half the actual weight of the vehicle also producing smooth non pulsing operation. With the dual hybrid propulsion there can be more smaller cylinders firing at a higher RPM (smoother) and producing more HP and less torque (less twisting forces on the engine) and more stored kinetic energy per equal weight of rotor mass vs. less larger cylinders firing at a lower (pulsing) RPM producing less HP and more torque (greater twisting forces on the engine hence a heavier design to handle these forces), a heavier rotor mass would be also needed.

The two smaller engines are a higher performance design, providing greater power densities. Similar to the method the military uses with there own battlefield equipment that require increased power densities, ie; kW output vs. lighter in weight=more effective.

When operating this dual hybrid propulsion with both engine and generator sets within these design parameters, permit's medium duty diesel engines to equal the duty cycle found only in heavy duty designed engines that don't contain these engine wear reducing techniques, technologies and configuration.

### Dual Hybrid Propulsion System Components

1. Liquid fueled engine one.
2. Generator one.
3. First electrical storage device.
4. Inverter one.
5. Motor/Generator.
6. Axle.
7. Drive shaft.
8. Main control panel.
9. Liquid fueled engine two.
10. Generator two.
11. Second electrical storage device.
12. Inverter two.
13. Voltage reducer for generator one.
14. Voltage reducer for generator two
15. Motor controller.
16. Process controller for engine one.
17. Process controller for engine two.
18. Wheel.
19. Throttle position sensor.
20. Load/speed monitoring device.
21. Manual-automatic selector.
22. Electric oil pump for liquid fuel engine one.
23. Electric oil pump for liquid fuel engine two.
24. Marine heat exchanger.

### SUMMURY

This invention enables the Dual Hybrid Propulsion System to accomplish the same work as a single series hybrid, parallel hybrid or conventional propulsion systems with a reduction in the fuel consumption. This lowers the operational cost and provide the most economical choice to power heavier vehicles in the future especially fleet vehicles, due to the volatility of fuel prices.

Sequence Listing

“Not Applicable”

What is claimed is:

1. The dual hybrid vehicle comprising: an electric motor (5); two liquid fueled engines (1-9); a first electrical energy storage device (3) connected to the electric motor (5) for powering the electric motor (5); two electrical energy generators (2-10), each generator is directly connected to one of the liquid fueled engines (1-9); they are both coupled to the first energy storage device (3) for providing a first charging voltage when the liquid fueled engines (1-9) are operating; also when both the liquid fueled engines (1-9) are operating and the electric motor (5) is powered; The electric motor (5) can be powered solely from the first electrical energy storage device (3) if required; two voltage reducers (13-14) are coupled to the electrical energy generators (2-10) and having a vehicle accessory voltage output, which is lower than the first charging voltage; and at least one grounded engaging drive wheel (18), which is rotatable by the electric motors.

2. The dual hybrid vehicle of claim 1 and further comprising: a motor controller (15) for rotating and controlling the rotational speed and torque of the electric motor (5); two process controllers (16-17) to control the liquid fueled engines (1-9); the process controllers (16-17) controls the starting, stopping and operational speed of the liquid fueled engines. The process controllers (16-17), controlling the liquid fueled engines (1-9) to vary the rotational speed of the liquid fueled engines (1-9) so as to be substantially synchronized with the required generator speed for proper charging rates and power output requirements from the electric motor (5); it also features an automatic start system to start one of the liquid fueled engines (1-9) to replenish the first electrical energy source (3) periodically and then automatically shut down when fully charged, this offers a zero emission for stop and go traffic when powered solely by the first electrical energy source (3) only power and minimum emissions when in the charge mode.

3. The dual hybrid vehicle comprising: a second electrical energy storage device (11) on the vehicle, which is coupled to the vehicle accessory voltage output.

4. A dual hybrid vehicle comprising: two voltage reducers (13-14) each one having their input coupled to both the generators (2-10) and the first electrical energy storage device (3); and having an output coupled to the second electrical energy storage device (11); to provide charging power at the lower voltage to the second electrical energy storage device (11).

5. The dual hybrid vehicle wherein: the electric motor (5) is operable as propulsion; and having two liquid fueled engines (1-9) powering the two generators (2-10) to provide charging power.

6. The dual hybrid vehicle comprising: two process controllers (16-17) coupled to both of the liquid fueled engines (1-9) for varying a rotational speed of the liquid fueled engines (1-9) so as to be substantially synchronized with the needed RPM for the power requirements from the electric motor (5) and the first electrical energy storage device (3) charging rates.

7. The dual hybrid vehicle comprising: a at least one ground engaging drive wheel (18), drive shaft (7) which is coupled to the electric motor (5) and is rotatable by the electric motor (5).

8. The dual hybrid vehicle wherein: the electric motor (5) is capable to be switchable to a generator mode for braking purposes, wherein the process controllers (16-17) are connected to the motor controller (15) to selectively switch the electric motor to the generator mode for charging the first electrical energy storage device (3); when the first electrical energy storage device (3); is at full charge the process controllers (16-17) sends the produced electrical power to a heating device to maintain a constant and sustainable braking power level slowing/stopping action; when the first electrical energy storage device (3) is at full charge and there is the two motor design, the process controllers (16-17) sends the produced electrical power to one electric motor which will function as a generator and one electric motor will function as a motor, applying input power in the opposite direction of the spin of the motor (reverse torque), converting the mechanical energy to heat.

9. The dual hybrid vehicle wherein: the two energy conversion devices comprising generators (2-10) and the energy conversion devices converts between electrical and mechanical energy.

10. The vehicle comprising: a power splitter capability from the two process controllers (16-17) equally dividing the power output of the two liquid fueled engines (1-9) and their generators (2-10) for a well balanced system.

11. The dual hybrid vehicle wherein: said the two liquid fueled engines (1-9) operate when extra drive power is required, and one of the liquid fueled engines (1 or 9) can be manually or automatically shut down when extra drive power is no longer vital.

12. The dual hybrid propulsion system; there are 4 manual settings (21) to control the liquid fueled motors (1-9), the first setting controls the speed of the liquid fueled engine one (1) to operate at the peak torque curve or the highest fuel economy engine speed for low load capabilities; the second setting controls the speed of the liquid fueled engine one (1) to operate at the peak horse power curve or the highest safe RPM operational speed, for emergency mode single engine power; the third setting controls the speed of both liquid fueled engines (1-9) operating at the peak torque curve or the highest fuel economy speed for medium load capabilities; forth setting controls the speed of both liquid fueled engines (1-9) operating at the peak horse power curve or the highest safe sustainable RPM operational speed for maximum power output.

13. The dual hybrid propulsion system; the automatic mode can be switched on and implemented when the manual mode is not desired. It works with the load/speed monitoring device (20) that connects to the vehicles speed odometer and the throttle position sensor (19) and the main control panel (8) with its sub internal components (4-12-13-14-15-16-17-20) working together to choose the proper use of the single or dual liquid fueled engines (1-9) and set the accurate number of engines engaged and exact engine speed to achieve the highest fuel economy per operating conditions.

14. The dual hybrid propulsion system, wherein: There is a marine liquid to liquid heat exchanger (24) that is placed inline between both engines (1-9) but has it's own separate coolant system. The process controller (16 or 17) on the standby liquid fueled engine (1 or 9) engages the electric oil pump ((22 or 23) every 15 minutes to keep the engines internals semi lubed.

15. The dual hybrid propulsion system wherein; the two liquid fueled engines (1-9) can be selectively switched on or off with the manual-automatic selector (21) and the said main control panel (8) with its sub internal components (4-12-13-14-15-16-17-20) with the load/speed monitoring device (20) to produce an unique electronic variable displacement series hybrid propulsion system.
